(19) United States
(12) Patent Application Publication
(10) Pub. No.: US 2014/0188527 A1
(43) Pub. Date: Jul. 3, 2014

(54) Enhanced Two-Dimensional Seat Map

(71) Applicants: Oliver Oxenham, San Francisco, CA (US); Wesley Oxenham, San Francisco, CA (US)

(72) Inventors: Oliver Oxenham, San Francisco, CA (US); Wesley Oxenham, San Francisco, CA (US)

(73) Assignee: STUBHUB, INC., San Francisco, CA (US)

(21) Appl. No.: 13/732,025

(22) Filed: Dec. 31, 2012

(51) Int. Cl. G06Q 10/02

(52) U.S. Cl. CPC G06Q 10/02
USPC 705/5

(57) ABSTRACT

Computing systems and methods for facilitating the review and purchase of event tickets include storage components that store information regarding ticketed events and venue information for seating arrangements, and also one or more processors that conduct activities regarding the review and purchase of tickets using an enhanced two-dimensional seat map. Actions include providing a display on a computing device including information regarding a venue that is used for ticketed events, accepting on the computing device a user input regarding seating arrangements for the venue, determining an attendance location for a ticketed event at the venue based upon the input, generating a two-dimensional representation or map of a region of interest at the venue from the determined attendance location, and displaying to the user the two-dimensional map. The computing device can be a cellular telephone or other small portable device, and the map can be created using scalable vector graphics and/or HTML5.

### TECHNICAL FIELD

The present disclosure relates generally to electronic commerce, and more particularly to the presentation of seating arrangements associated with automated ticket transactions.

### BACKGROUND

Computer systems and networks have facilitated the tasks of buying, selling and transferring goods. For example, global computer networks, such as the Internet, have allowed purchasers to relatively quickly and efficiently seek and purchase goods online Similarly, global computer networks provide an efficient and cost-effective medium for sellers to advertise, offer, provide, and sell their goods. Electronic commerce companies provide buyers and sellers with online services and the infrastructure to accept orders of goods from remote purchasers, to perform the financial transactions necessary to confirm and complete the sale of goods, to ship or distribute the goods to remote purchasers, and to perform other related logistics.

One example of a market for goods within the realm of electronic commerce is the online ticket. Many different websites and parties buy, sell and provide marketplaces for tickets online, and the ability for individuals to buy and sell tickets online is now generally well known. These tickets can be for a variety of live events, such as, for example, sports, concerts, theater, and other entertainment events. In many instances, a buyer looks for available tickets on a ticket marketplace or other online listing and decides which, if any, of the available tickets are of interest to the buyer for possible purchase. The buyer can be provided with information such as an event date and time, venue, the price of the tickets, prices of closed listings (both sold and unsold), and location of the tickets, such as through a seating chart of the venue. Based on these and possibly other informational items, the user can select desired tickets from among multiple listings at the same website or online presence.

Unfortunately, such ticket selections can be based on limited information, which may result in the buyer purchasing a ticket or tickets that are not optimized as being the “best” for that buyer given the desired circumstances of that buyer. For example, a given buyer might be willing to pay a little more for seats at the same venue but at an improved location, such as seats that are closer or have a different perspective of the event, or seats having added perks such as special club or concessions access. Other features such as benches, wider chairs, padded seats, usher service and the like might also be appealing to some purchasers, where such items might vary from one location to another at a given venue or event.

In addition, many online ticket services have presentations, seating maps and other features that tend to work well in full service browsers, such as for PCs, laptops and other computers. Such presentations and features sometimes do not work as well on limited web browsers, however, such as those that are often used for cellular telephones and other similar mobile devices. Unfortunately, this can result in a loss of business for online ticket providers when users may wish to purchase tickets or otherwise conduct related research on their phones or other similar devices.

Although many systems and methods for purchasing tickets and attending ticketed events have generally worked well in the past, there is always a desire for improvement. In particular, what is desired are systems and methods that provide potential ticket purchasers with more informed ways to select and purchase tickets to various ticketed events, even where cellular phones or other mobile devices are used.

### BRIEF DESCRIPTION OF THE DRAWINGS

The included drawings are for illustrative purposes and serve only to provide examples of possible systems and methods for the disclosed enhanced two-dimensional seat maps, such as for use in the purchase of tickets to various ticketed events on a cellular telephone or other mobile device. These drawings in no way limit any changes in form and detail that may be made to that which is disclosed by one skilled in the art without departing from the spirit and scope of this disclosure.

FIG. 1 illustrates in block diagram format an exemplary computing system adapted for implementing the purchase of tickets for ticketed events according to one embodiment of the present invention.

FIG. 2 illustrates in block diagram format an exemplary computer system suitable for implementing on one or more devices of the computing system in FIG. 1 according to one embodiment of the present invention.

FIGS. 3A-3B illustrate screenshots of exemplary service provider pages depicting overhead graphical representations of venues for ticketed events of interest according various embodiments of the present invention.

FIGS. 4A-4H illustrate screenshots of an exemplary process of developing virtual views for particular seats or regions of interest at venues for ticketed events according to one embodiment of the present invention.

FIG. 5 illustrates screenshots of exemplary service provider pages depicting a progression for selecting tickets and displaying seat views for the selected seats for a ticketed event according to one embodiment of the present invention.

FIG. 6A illustrates screenshots of exemplary service provider pages depicting graphical representations of selected seats from overhead map and virtual views for ticketed events of interest according to one embodiment of the present invention.

FIGS. 6B and 6C illustrate representations of mobile devices depicting various screenshots of exemplary service provider pages that utilize overhead map and virtual views according to various embodiments of the present invention.

FIG. 7 provides a flowchart of an exemplary method exemplary method of facilitating a ticket selection for a ticketed event using an enhanced two-dimensional seat map according to one embodiment of the present invention.

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used, and changes may be made without departing from the spirit and scope of the invention.

The present invention relates in various embodiments to devices, systems and methods involving activities with respect to the online purchase of tickets to ticketed events. In various particular embodiments, the subject devices, systems or methods can involve one or more user devices in communication over a network. Such a network can facilitate the improved discovery, perusal and purchase of tickets online, such as through a more robust use of a cellular telephone or other mobile device. The subject systems or methods can utilize an enhanced two-dimensional interactive seat map. This seat map can be created from a three-dimensional model, and can provide the user with an enhanced view of the venue by conveying angles, depth, height and other viewing or seating aspects. The seat map can be created from images and information that is publicly available, such as over the Internet, and can be provided using scalable vector graphics (“SVG”) and/or HTML5, such that generally improved presentations can be made on phones and other mobile devices.

While the various examples disclosed herein focus on particular aspects regarding the purchase of tickets, it will be understood that the various inventive principles and embodiments disclosed herein can be applied to other types of ticketed applications and arrangements as well. For example, a ticket purchase done in person or on a closed or proprietary computing system may utilize one or more of the aspects and features found in the various systems and methods provided.

### Systems and Devices

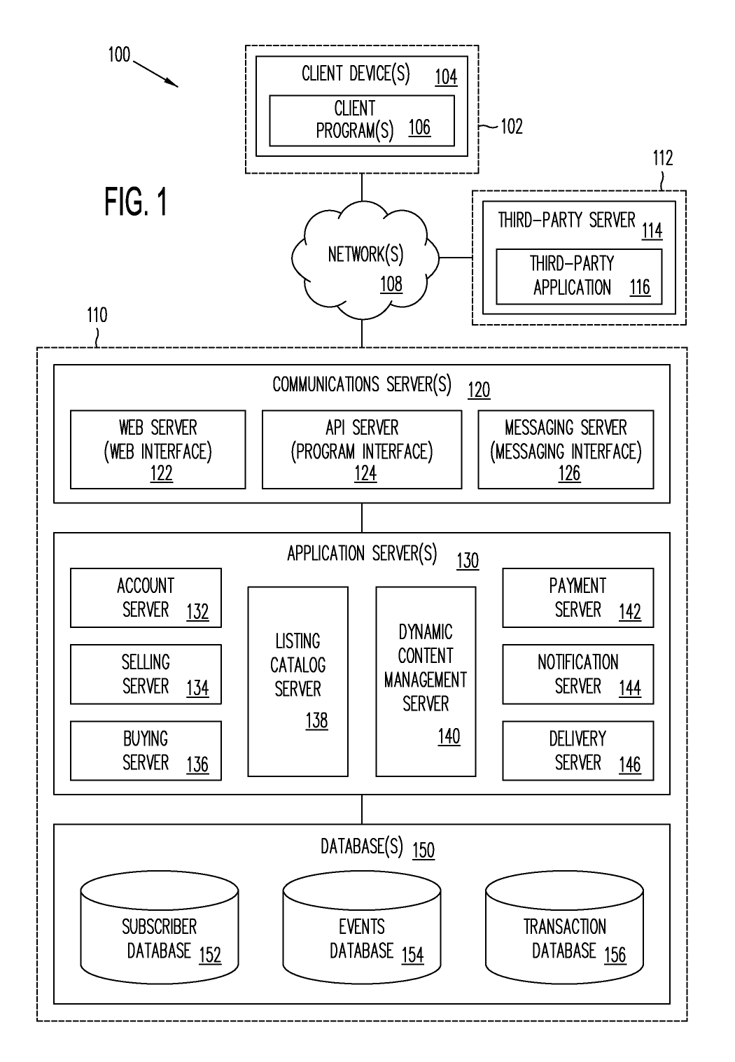

Beginning with FIG. 1, an exemplary embodiment of a computing system adapted for implementing the purchase of tickets for ticketed events is illustrated in block diagram format. As shown, computing system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Computing system 100 can include, among various devices, servers, databases and other elements, a client 102 that may comprise or employ one or more client devices 104, such as a laptop, a mobile computing device, a PC, and/or any other computing device having computing and/or communications capabilities in accordance with the described embodiments. In particular, it is specifically contemplated that client devices 104 can include a cellular telephone or other similar mobile device that a user can carry on or about his or her person and access readily.

Client devices 104 generally may provide one or more client programs 106, such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator), and so forth. One or more of client programs 106 may display various graphical user interfaces (GUIs) to present information to and/or receive information from one or more of client devices 104.

As shown, client 102 can be communicatively coupled via one or more networks 108 to a network-based system 110. Network-based system 110 may be structured, arranged, and/or configured to allow client 102 to establish one or more communications sessions with network-based system 110 using various computing devices 104 and/or client programs 106. Accordingly, a communications session between client 102 and network-based system 110 may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data and/or voice communications between client 102 and the network-based system 110 may be sent and received over one or more networks 108 such as the Internet, a WAN, a WWAN, a WLAN, a mobile telephone network, a landline telephone network, a VoIP network, as well as other suitable networks. For example, client 102 may communicate with network-based system 110 over the Internet or other suitable WAN by sending and or receiving information via interaction with a web site, e-mail, IM session, and/or video messaging session. Any of a wide variety of suitable communication types between client 102 and system 110 can take place, as will be readily appreciated. In particular, wireless communications of any suitable form may take place between client 102 and system 110, such as that which often occurs in the case of mobile phones or other personal mobile devices.

In various embodiments, computing system 100 can include, among other elements, a third party 112, which may comprise or employ a third-party server 114 hosting a third-party application 116. In various implementations, third-party server 314 and/or third-party application 116 may host a web site associated with or employed by a third party 112. For example, third-party server 114 and/or third-party application 116 may enable network-based system 110 to provide client 102 with additional services and/or information, such as additional ticket inventory. In some embodiments, one or more of client programs 106 may be used to access network-based system 110 via third party 112. For example, client 102 may use a web client to access and/or receive content from network-based system 110 after initially communicating with a third-party web site 112.

Network-based system 110 may comprise one or more communications servers 120 to provide suitable interfaces that enable communication using various modes of communication and/or via one or more networks 108. Communications servers 120 can include a web server 122, an API server 124, and/or a messaging server 126 to provide interfaces to one or more application servers 130. Application servers 130 of network-based system 110 may be structured, arranged, and/or configured to provide various online marketplace and/or ticket fulfillment services to users that access network-based system 110. In various embodiments, client 102 may communicate with applications servers 130 of network-based system 110 via one or more of a web interface provided by web server 122, a programmatic interface provided by API server 124, and/or a messaging interface provided by messaging server 126. It can be appreciated that web server 122, API server 124, and messaging server 126 may be structured, arranged, and/or configured to communicate with various types of client devices 104 and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, and so forth. API server 124 may be arranged to communicate with various client programs 106 and/or a third-party application 116 comprising an implementation of API for network-based system 110. Messaging server 126 may be arranged to communicate with various messaging clients and/or applications such as e-mail, IM, SMS, MMS, telephone, VoIP, video messaging, and so forth, and messaging server 126 may provide a messaging interface to enable access by client 102 and/or third party 112 to the various services and functions provided by application servers 130.

When implemented as an online ticket marketplace, application servers 130 of network-based system 110 may provide various online marketplace and ticket fulfillment services including, for example, account services, buying services, selling services, listing catalog services, dynamic content management services, delivery services, payment services, and notification services. Application servers 130 may include an account server 132, a buying server 134, a selling server 136, a listing catalog server 138, a dynamic content management server 140, a payment server 142, a notification server 144, and/or a delivery server 146 structured and arranged to provide such online marketplace and ticket fulfillment services.

Application servers 130, in turn, may be coupled to and capable of accessing one or more databases 150 including a subscriber database 152, an active events database 154, and/or a transaction database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments. Further details regarding the various components, capabilities and features of computing system 100 can be found at, for example, U.S. patent application Ser. No. 13/293,854, entitled “Intelligent Seat Recommendation,” filed on Nov. 10, 2011, which is incorporated herein by reference in its entirety.

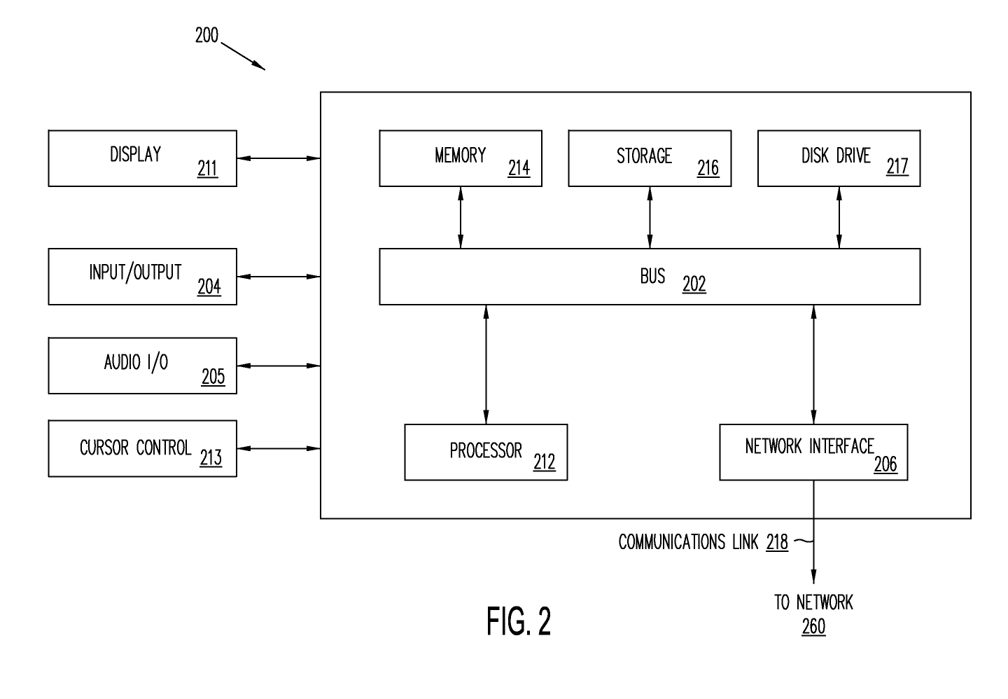

Continuing with FIG. 2, an exemplary computer system 200 suitable for implementing on one or more devices of the computing system in FIG. 1 is depicted in block diagram format. In various implementations, a device that includes computer system 200 may comprise a personal computing device (e.g., a smart or mobile phone, a computing tablet, a personal computer, laptop, PDA, Bluetooth device, key FOB, badge, etc.) that is capable of communicating with a network. The ticket provider and/or a payment provider may utilize a network computing device (e.g., a network server) capable of communicating with the network. It should be appreciated that each of the devices utilized by users, ticket providers, and payment providers may be implemented as computer system 200 in a manner as follows.

Computer system 200 can include a bus 202 or other communication mechanism for communicating information data, signals, and information between various components of computer system 200. Components include an input/output (I/O) component 204 that processes a user action, such as selecting keys from a keypad/keyboard, selecting one or more buttons or links, etc., and sends a corresponding signal to bus 202. I/O component 204 may also include an output component, such as a display 211 and a cursor control 213 (such as a keyboard, keypad, mouse, etc.). An optional audio input/output component 205 may also be included to allow a user to use voice for inputting information by converting audio signals. Audio I/O component 205 may allow the user to hear audio. A transceiver or network interface 206 transmits and receives signals between computer system 200 and other devices, such as another user device, a merchant server, or a payment provider server via a network. In various embodiments, such as for many cellular telephone and other mobile device embodiments, this transmission can be wireless, although other transmission mediums and methods may also be suitable. A processor 212, which can be a micro-controller, digital signal processor (DSP), or other processing component, processes these various signals, such as for display on computer system 200 or transmission to other devices over a network 260 via a communication link 218. Again, communication link 218 can simply be a wireless communication form in some embodiments. Processor 212 may also control transmission of information, such as cookies or IP addresses, to other devices.

Components of computer system 200 also include a system memory component 214 (e.g., RAM), a static storage component 216 (e.g., ROM), and/or a disk drive 217. Computer system 200 performs specific operations by processor 212 and other components by executing one or more sequences of instructions contained in system memory component 214. Logic may be encoded in a computer readable medium, which may refer to any medium that participates in providing instructions to processor 212 for execution. Such a medium may take many forms, including but not limited to, non-volatile media, volatile media, and transmission media. In various implementations, non-volatile media includes optical or magnetic disks, volatile media includes dynamic memory, such as system memory component 214, and transmission media includes coaxial cables, copper wire, and fiber optics, including wires that comprise bus 202. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Such software may be stored and/or used at one or more locations along or throughout the system, at client 102, network-based system 110, or both.

### Two-Dimensional Seat Map

As will be readily appreciated, the foregoing networks, systems, devices, methods and variations thereof can be used to implement the improved selection and purchase of tickets in a more informed and intelligent fashion. Rather than having users resort to known procedures involving the selection and purchase of tickets, a more user friendly system having a robust user interface and process involving the use of an enhanced two-dimensional seat map that can be accessed on a phone, other mobile device or any computing device can be provided. Such a seat map can be created using virtual three-dimensional or augmented reality views in some cases, and can be implemented using SVG and/or HTML5, particularly where use in association with mobile devices is preferred. In various embodiments, a ticket selection and purchase using such a seat map can be facilitated by an online service provider, such as, for example, StubHub, Inc. of San Francisco, Calif.

In various embodiments, ticketed events can be social or recreational events, such as concerts, musicals, shows, fairs, amusement parks, sporting events and the like. Alternatively, such events can be business related events, such as business meetings, conferences, retreats, and the like. In various embodiments, one or more networks, systems, devices and methods that assist users in selecting and purchasing tickets using an enhanced two-dimensional seat map that can be interactive, can include the use of 2D images created from 3D models, can involve the use of SVG and/or HTML5, and can otherwise involve specialized hardware and/or computer programs. Such hardware and/or programs can be located on user devices, on system servers, and/or distributed across an overall network.

Available tickets, sections and/or price ranges can be obtained or provided to the user by way of structured data from the service provider and/or other sources. Such data can be presented to the user in a manner so as to readily facilitate the selection and purchase of tickets with respect to preferred sections, seats, concessions and/or pricing options that may be suitable. Such section or pricing options can be variable or varied depending upon the number of tickets desired and preferred section or pricing parameters.

One way to facilitate providing users with information to make more intelligent and informed way to select and purchase tickets to various ticketed events can involve providing an enhanced two-dimensional seat map. Such a seat map or interface can involve two-dimensional views or maps created from three-dimensional models, augmented realities, or both. This seat map for a venue can be created using 3GS, 4GS, HTML4, HTML5, or any other suitable mapping language or protocol. The use of SVG can allow layers to be presented for a more robust presentation, even on mobile devices. Such a map presentation involving 3D representations can be used in conjunction with a 2D map to show sections and rows around the venue in a more effective manner. Toggling back and forth between the 2D and the 3D maps can then take place when a user desires to see what the view looks like from a particular seating location on a simpler but more distributed 2D map.

In various embodiments, a user can access the interactive seat map or interface from any suitable remote location with any suitable computer or device. Such remote access can involve taking a virtual “walk” around the venue, seeing available seats and prices at different places along the walk, and possibly purchasing one or more tickets after seeing the view from each seat or other attendance location of interest. In some embodiments, a user can access the interactive seat map or interface while he or she is physically present at or near the venue, such as by way of a smart phone or other personal mobile device. This can allow a user to see virtually what a view looks like at a different venue location, and can even allow the user to see what the virtual views look like from the exact location of the user.

When a user is at a given venue, the user can be permitted to use a smart phone, tablet, laptop computer or other portable device to access the interactive seat map. In addition to seeing different views from different locations at the venue, the user could also purchase seats for future events or concessions. In some embodiments, a user can compare views from different seats and select one or more seats for one or more ticketed events, either physically at the venue or virtually through the portable computing device of the user.

In various embodiments, this can involve the user purchasing tickets for a given seat or other attendance location right at the exact seat or attendance location. This can involve the use of GPS, triangulation or other specific location services. For example, a user having a smart phone can physically walk about a venue, whereby the system will track the location of the user by way of the smart phone. In this manner, the user can be certain of the exact tickets that he or she is purchasing or otherwise expressing an interest. This can relieve some users of the need to manually determine a section, row and seat number for their exact location upon purchase or inquiry.

In the event that no tickets are available for a given seat at a given future ticketed event, or where the user may just wish to know when a particular seat or seats are available for purchase for any future event, the user can be provided with an option to express an interest in the particular seat(s). For example, where seats in Row 20 of Section 125 are not available for any future games, but the user would really like to watch a game from that particular location, the user can indicate that they would like to be notified whenever tickets for that row do go on sale or are otherwise made available.

As noted with respect to FIG. 2 above, a computer system 200 can include one or more processors 212 and one or more memories or storage devices 214, 216. Such a computer system 200 can be part of a user device, part of one or more servers on a network-based system, or some combination thereof. Again, system 200 can be all or part of a cellular telephone or other mobile user device in some embodiments. In various embodiments, one or more of the processors 212 of interest can be located on the user device only, on the server side only, or on both. Similarly, one or more of storage devices 214, 216 can be located on the user device only, the server side only, or on both. A given computing system can include one or more memory devices or storage components 214, 216 adapted to store event information regarding one or more upcoming ticketed events, venue information regarding seating arrangements and views from seats, and/or images and information used to generate virtual views. In addition, one or more processors 212 can be in communication with the one or more memory devices or storage components and can be adapted to facilitate providing a display on a computing device to a user thereof, the display including information regarding a venue that is used for one or more ticketed events.

Further functionality of the one or more processors 212 can include the ability to accept on the smart phone, mobile device, or other computing device a first input from the user regarding seating arrangements for the venue, determine a first attendance location for a ticketed event at the venue based upon the first input, generate a first virtual view of a region of interest at the venue from the determined first attendance location, and display to the user the first virtual view. The first virtual view can be displayed on the same display component that displays the information regarding the venue, such as on a sole or primary display of a smart phone or mobile device. In various embodiments, the computing system can also include a display component adapted to display to the user the first virtual view. Further, the attendance location can be a specific seat at the venue selected by the user, such as while the user is physically at the selected seat.

In various embodiments, the one or more processors 212 can be located on a server while the display and user inputs can be located on a remote mobile user device, such as a smart phone. Processor(s) 212 can be further adapted to accept a request to purchase tickets to the ticketed event from the user, wherein the request is based at least in part on the display of the first virtual view. The processor(s) 212 can be further adapted to accept a second input from the user indicating a user interest in the determined first attendance location, and send a communication to the user at a later time when tickets at or near the determined first attendance location become available for purchase for another ticketed event at the venue.

In still further embodiments, the processor(s) 212 can be further adapted to accept a second input from the user regarding alternative seating arrangements for the venue, determine a second attendance location for the ticketed event at the venue based upon the second input, generate a second virtual view of the region of interest at the venue from the determined second attendance location, and display to the user the second virtual view. Such displaying can involve a virtual reality transition from the first to the second virtual views.

Various screenshots of exemplary pages from a potential service provider having an enhanced two-dimensional seat map will now be provided for purposes of illustration. It will be understood that such screenshots and pages are not intended to be limiting, and that these merely provide examples of what such pages may contain. Furthermore, not every noted page need be provided for a given service provider, and additional pages not shown or described might also be included in some instances.

In various embodiments, it is specifically contemplated that enhanced 2D seat maps be provided. Such enhanced 2D seat maps can include the use of 2D images created from 3D models, can involve the use of SVG and/or can involve the use of HTML5, such that more robust presentations can be advantageously provided to users of smart phones and other personal mobile devices. These features can be present as part of one or more specialized applications or “apps” that can be provided to device users, with the software or apps being programmed, provided and/or serviced by one or more remote system servers. Such one or more remote system servers can also be adapted to interact with the apps on user devices to facilitate a smooth and streamlined presentation and purchase process for users.

In general, SVG can be an XML-based vector image format for two-dimensional graphics, with support for interactivity and animation. Various SVG specifications are generally well known and have been open standard since about 1999. Although many SVG implementations work well with full format browsers, many mobile browsers can support some form of SVG, such as SVGT 1.1 and 1.2. It is specifically contemplated that any and all forms of SVG that can be supported on mobile devices can be used in association with the present invention. HTML5 is generally known as the fifth revision of the HTML standard markup language for presenting content on the Internet. Various implementations and features using HTML5 are able to run on relatively low power devices, such as, for example, smart phones, tablets, other mobile devices.

When used in conjunction with SVG applications and implementations that can accommodate HTML5, this combination can enable a more robust presentation of images, virtual views, animations and other user interaction features on a mobile device. SVG graphics allow maps to be zoomed in and out without any loss in quality. This gives the ability to add extra level of details such as concessions, wheelchair access, food stalls, children friendly area, and the like on top of the interactive seat map at various zoom levels. Moreover, SVG graphics with HTML 5 allows every element of a seat map (zone, section, row, seat, and so forth) to be made interactive and to respond to user actions such as hover, touch, swipe, double tap, or other forms of user input. In some embodiments, every element can be custom-colored based on a desired outcome. For instance, a custom heat map showing ticket sales by section can be seen in screenshot 350 below.

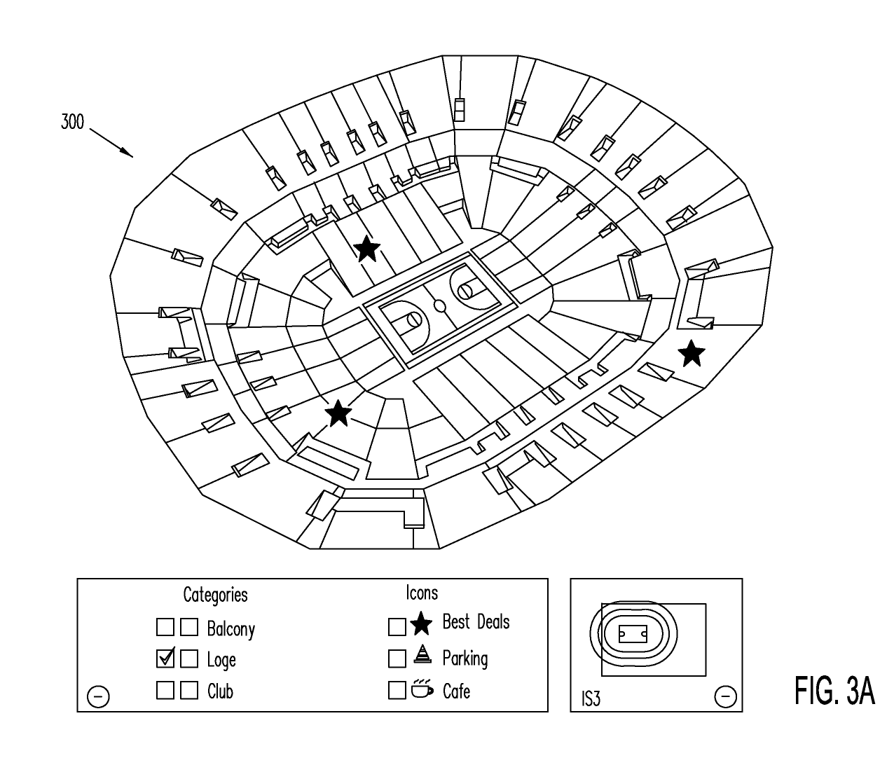

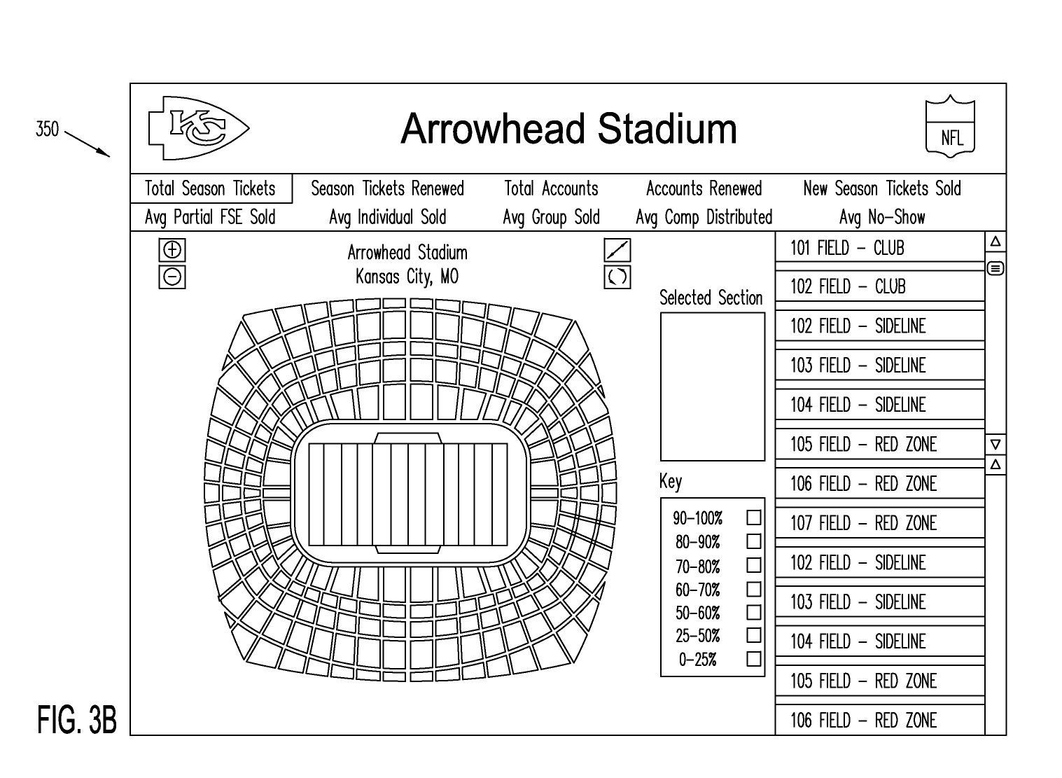

Turning next to FIGS. 3A-3B, screenshots of exemplary service provider pages depicting overhead maps or graphical representations of venues for ticketed events of interest are provided. As shown in screenshot 300 in FIG. 3A, an overhead yet somewhat perspective based graphical overall representation of TD Banknorth Garden in Boston is provided. This map shown in screenshot 300 is somewhat three-dimensional yet comprehensive, and can allow a user to more readily see a full or partial two-dimensional seat map of the venue, such as upon the selection of a section or region of interest in a quick and efficient manner. Similarly, FIG. 3B provides a screenshot of an overhead map 350 of Arrowhead Stadium, which also allows a user to readily select a given section or region. Further actions, such as interactive three-dimensional rendering, different view presentations, seat selection, ticket purchase, and so forth based on these initial selections can then follow.

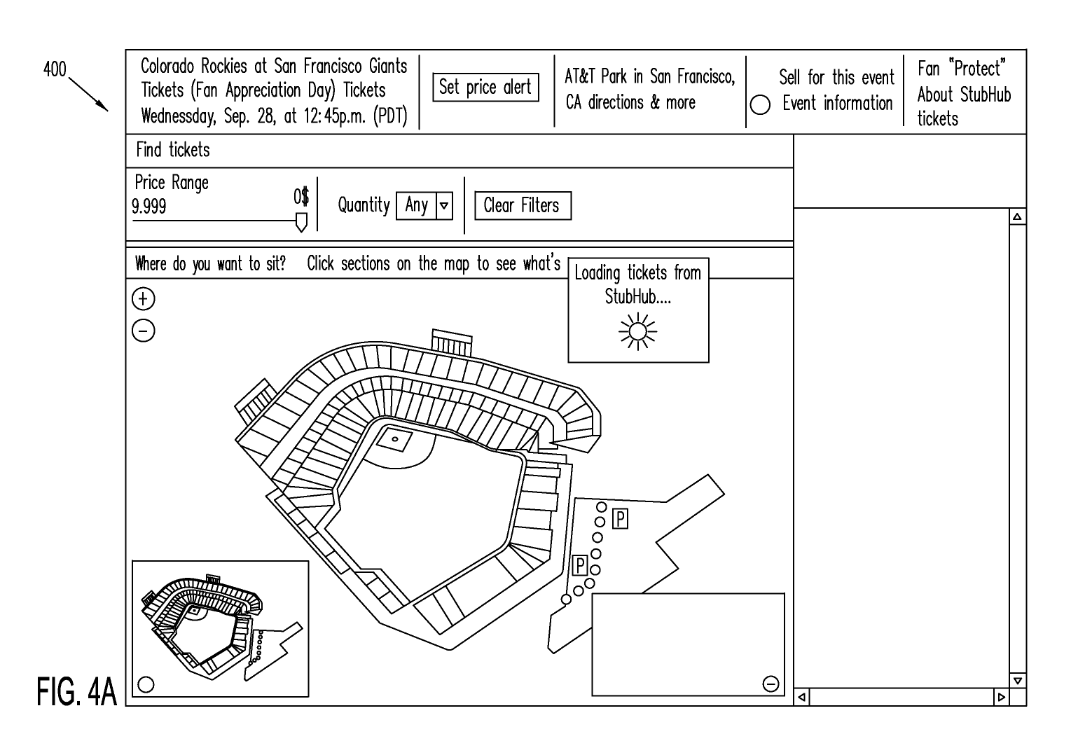

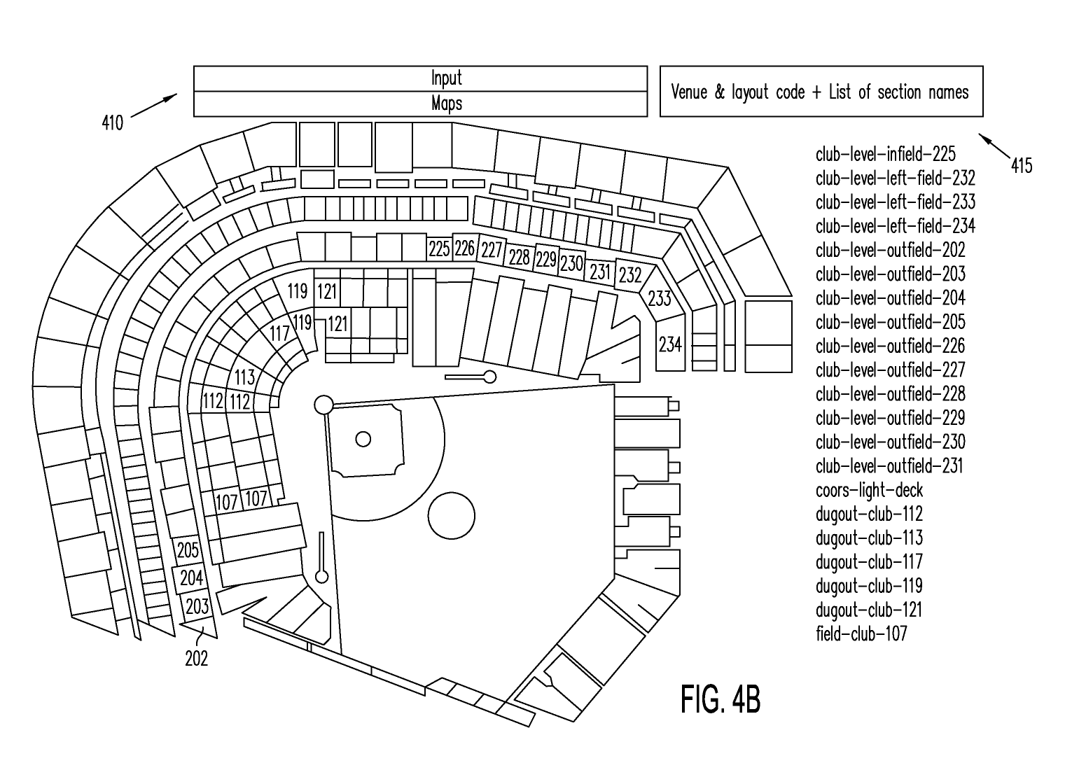

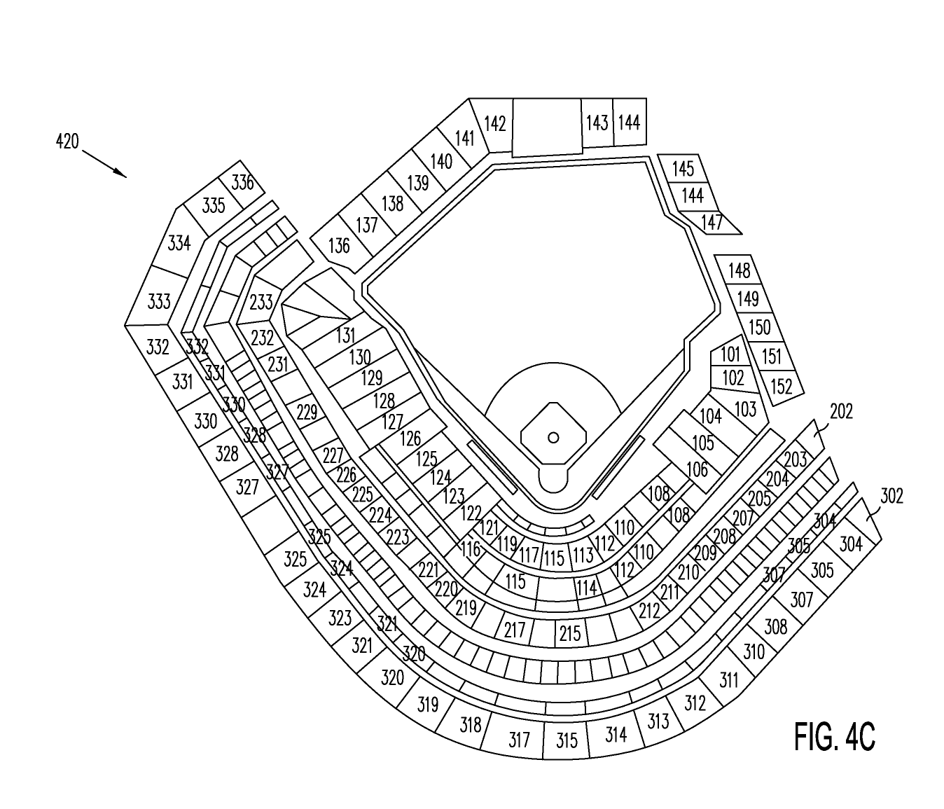

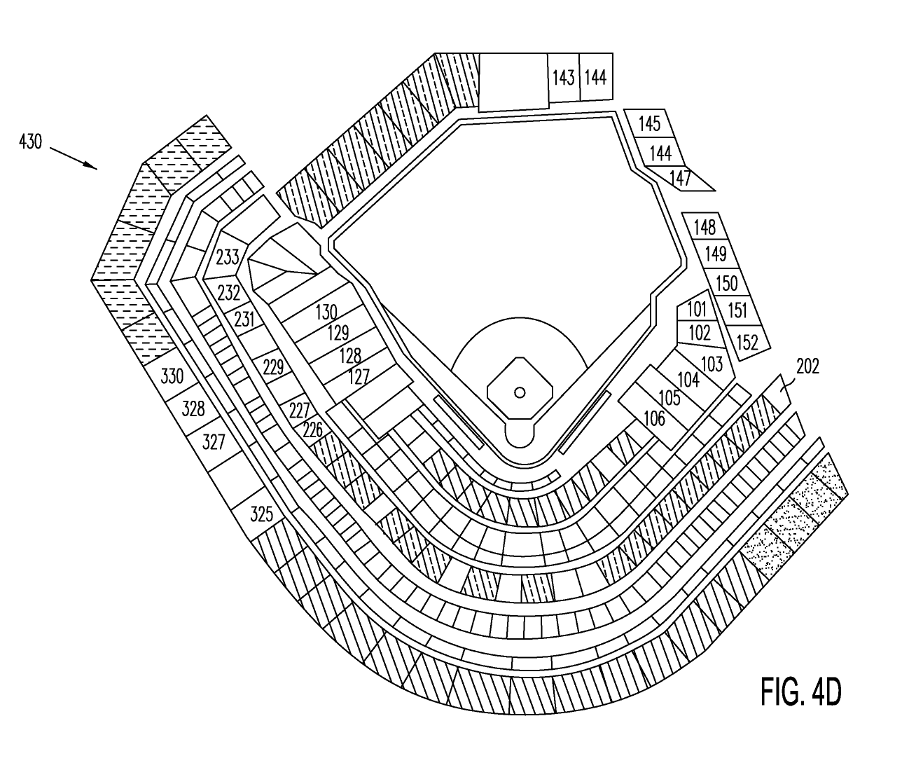

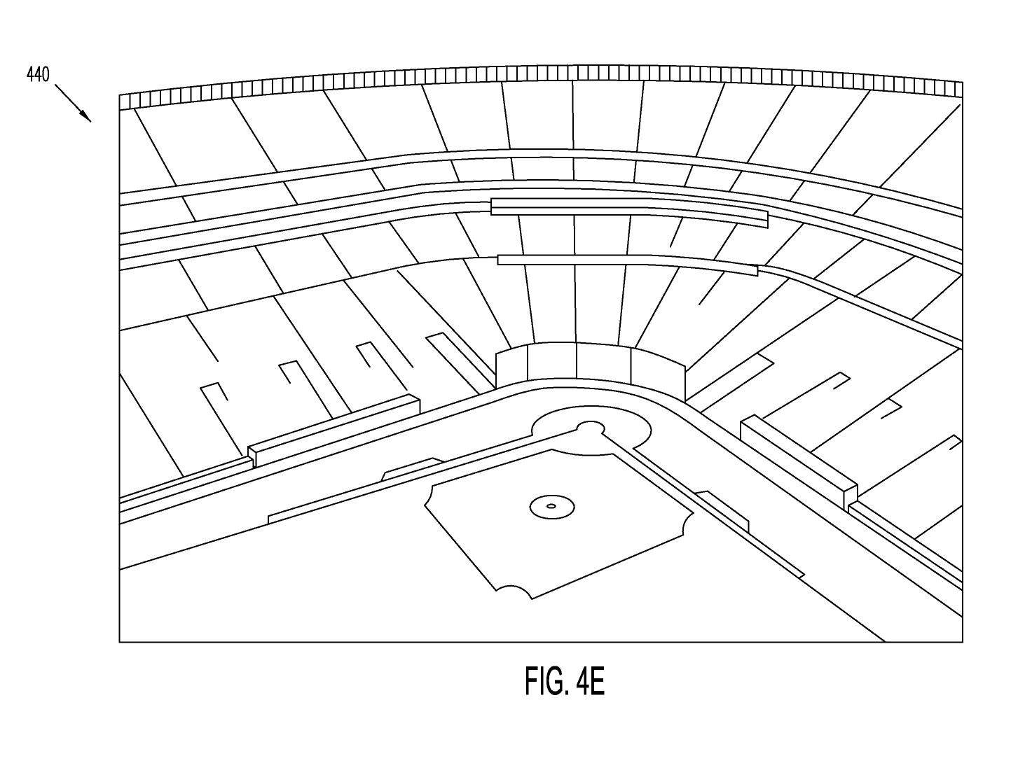

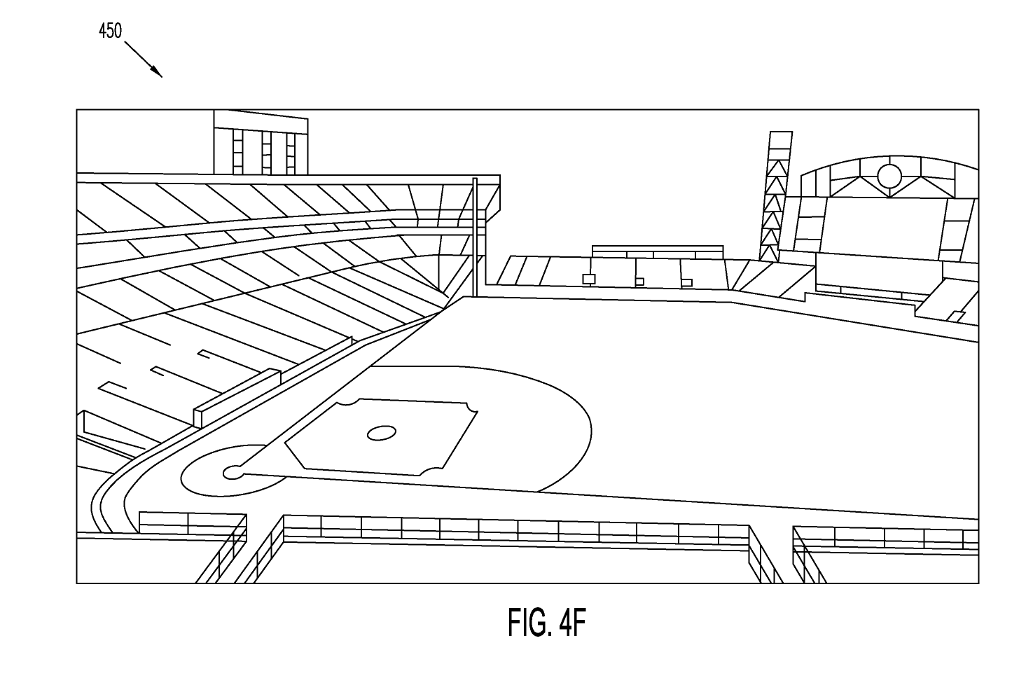

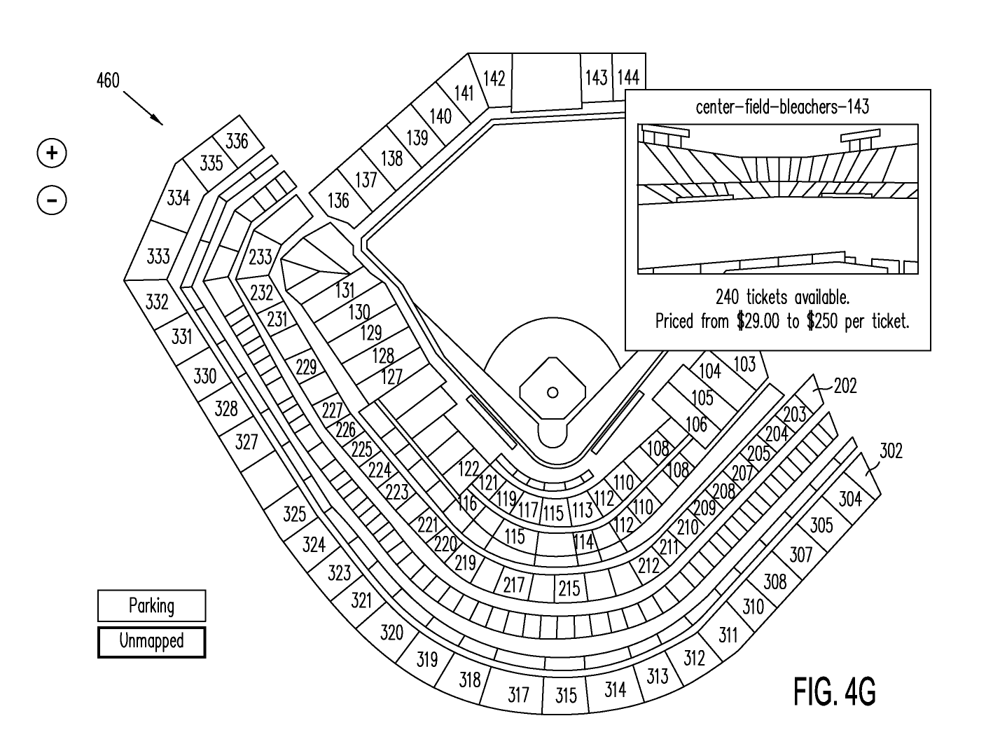

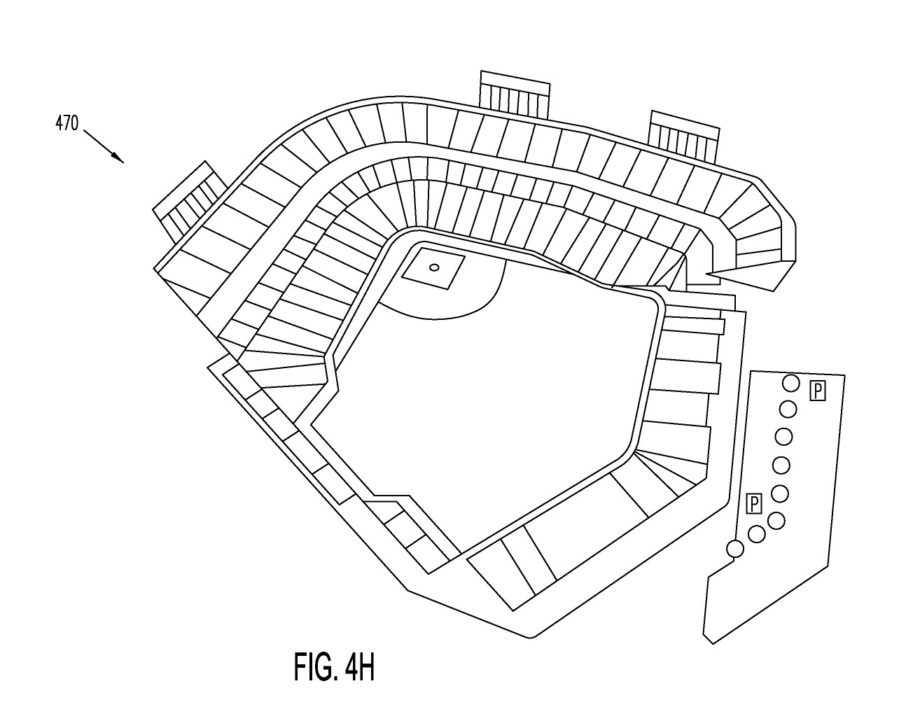

FIGS. 4A-4H illustrate screenshots of an exemplary process of developing virtual views for particular seats or regions of interest at venues for ticketed events according to one embodiment of the present invention. Starting with FIG. 4A, screenshot 400 depicts an online ticket search page for a baseball venue. The page shown includes a virtual representation of the ballpark, which is AT&T Park in San Francisco. It will be readily appreciated that the various depictions, overhead maps, 2D and 3D views provided to a user of the service provider can be generated in a number of ways. In some embodiments such generation can involve the use of SVG, which allows layers to be placed on the map or presentation, and also HTML5, which allows the map or presentation to be interactive on a phone or other mobile device.

Continuing with FIG. 4B various forms of input can be provided as an early part of the virtual view generation process. As shown, screenshot 410 depicts a general 2D overhead map of a venue, while screenshot or input table 415 provides a venue and layout code in the form of a list of section names. Other formats for such data can also be used, as will be readily appreciated. Upon having these initial input items, as well as other potential input items, a drawing rendition can be generated, such as that shown in screenshot 420 in FIG. 4C.

FIG. 4D then provides a screenshot 430 of a mapping process that uses the drawing of FIG. 4C, as well as other data or information to provide a more robust depiction of a venue and its various sections or regions, such as by a color coding. At the next screenshot 440 shown in FIG. 4E, various three-dimensional scenes and virtual views for sections or regions of the ballpark can be developed. These views can be developed using SVG and taking existing images, information and data, such as that which is already stored on the system for a given venue to layer a created view. Adjustments to these virtual views using SVG can also be undertaken, such as through the use of even further images and information. A 3D scenes export process can then take place to store numerous virtual views, such as that which is shown in screenshot 450 in FIG. 4F.

Final results or output of this process are then shown in screenshots 460 and 470 of FIGS. 4G and 4H. These representations can be those that are actually provided to users of the app, program or other presentation by the service provider. This output can be in the form of interactive maps, which may be 2D or 3D, as may be desired. As shown in screenshot 460, an enhanced two-dimensional seat map can be in the form of an overhead map of the entire venue, with some or all of the section numbers labeled or otherwise provided. One or more insert portions can provide a different view from a seat or region of interest, as shown. As shown in screenshot 470, a general overhead 3D view of the venue can also be an output, similar to that which is shown in FIG. 4A. Again, this simple output view in screenshot 470 of FIG. 4H can be overlaid with one or more additional items, views or informational boxes, such as that which is shown in screenshot 400 in FIG. 4A.

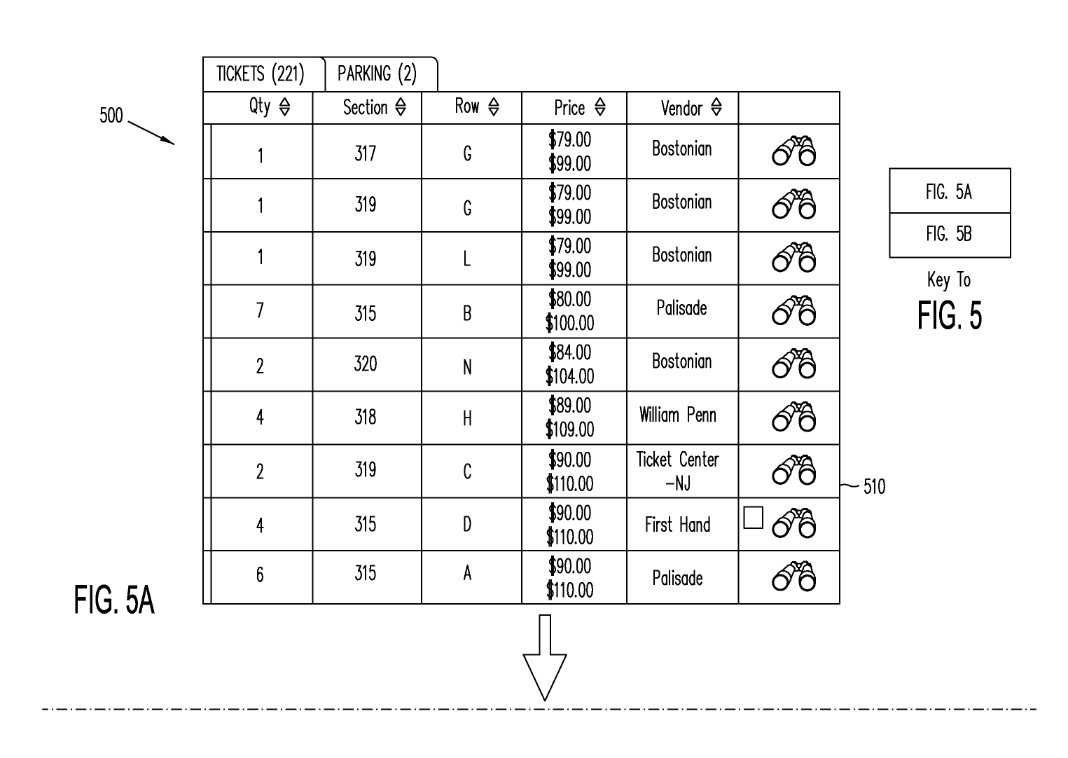

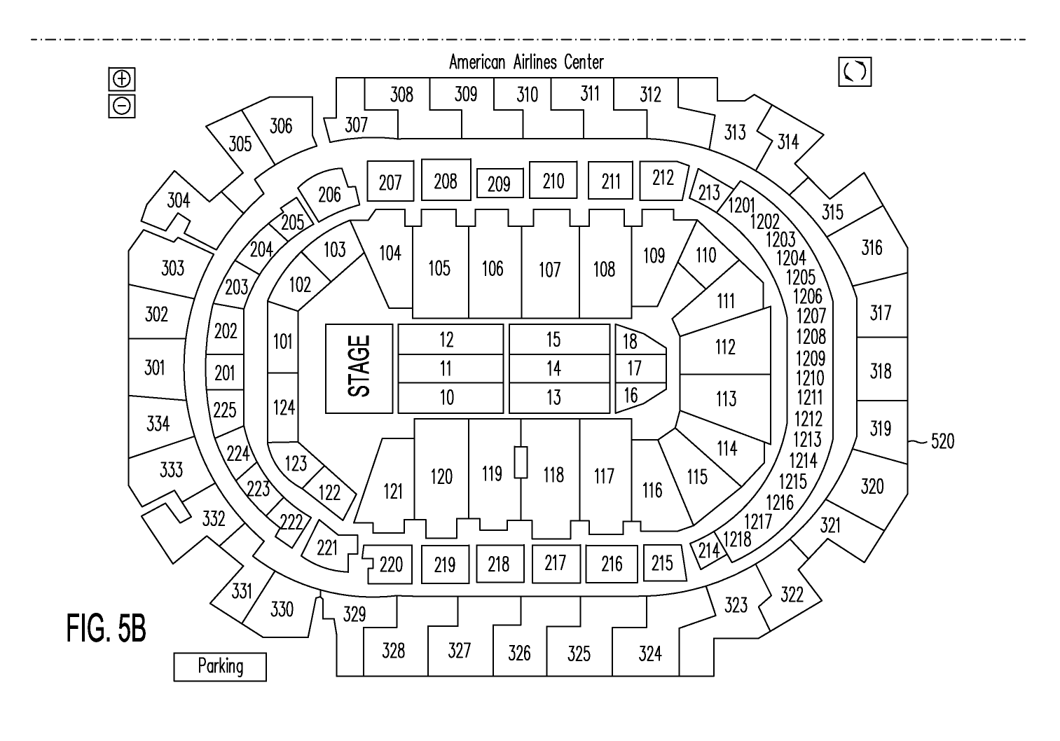

FIG. 5 illustrates screenshots of exemplary service provider pages depicting a progression for selecting tickets and displaying seat views for the selected seats for a ticketed event according to one embodiment of the present invention. Progression 500 can include a listing of available tickets 510, which can be linked to an overhead 2D map 520. These displays can both be linked to other displays or presentations, such as, for example, an interactive three-dimensional seat map interface and display, as may be desired. As one particular example, a user may decide to select seats that are fairly inexpensive in Section 319 as shown in listing 510. The overhead 2D map 520 can then show the user the location of Section 319 within the overall venue, while another virtual view or map (not shown) can also show what the view looks like from that section. The user can be permitted to toggle back and forth between the various presentations, as may be desired.

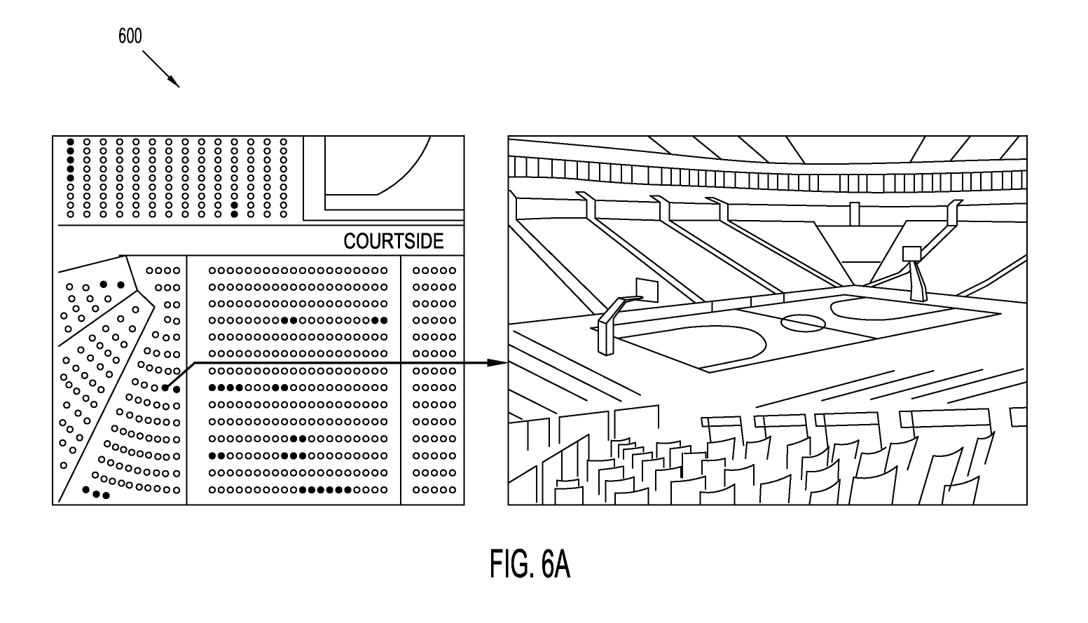

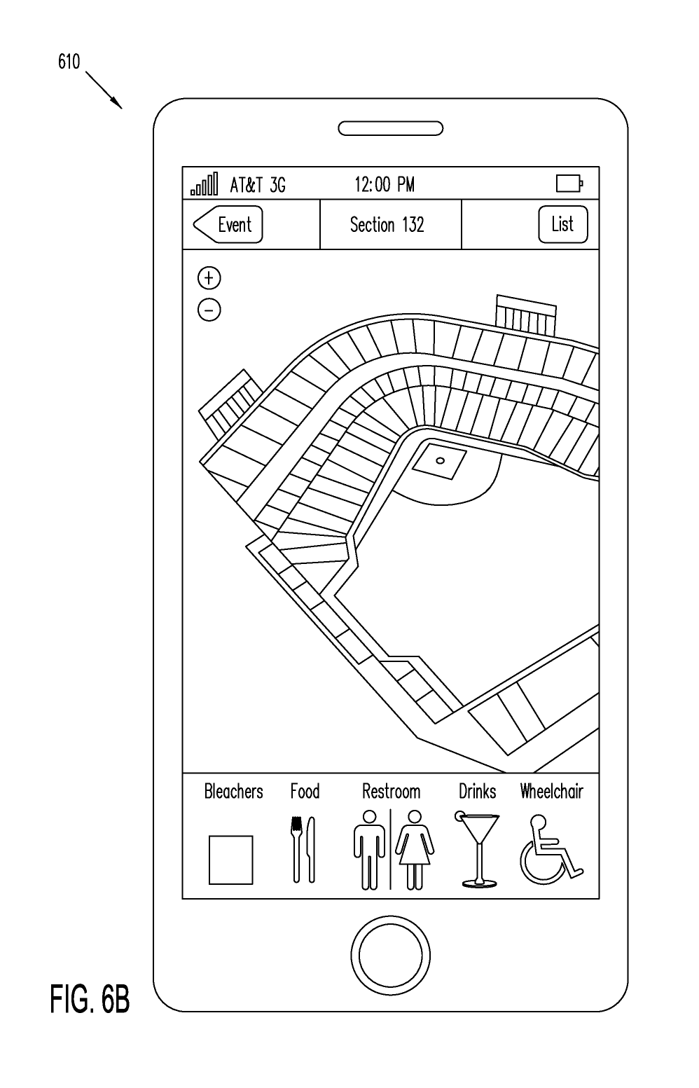

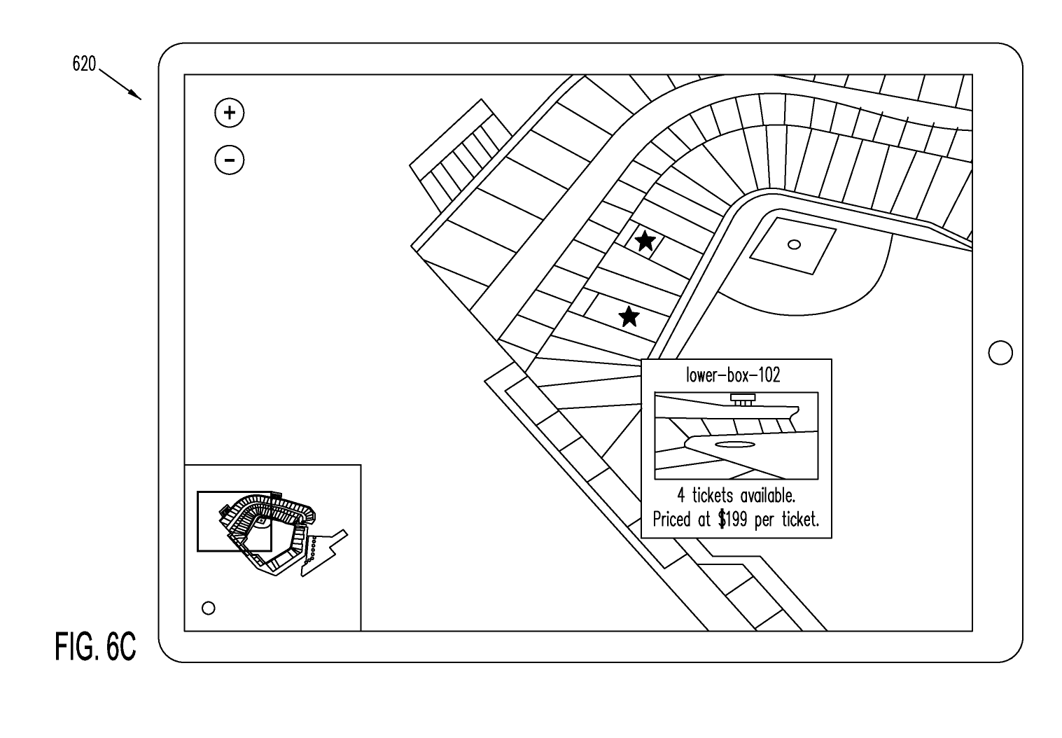

FIG. 6A illustrates screenshots of exemplary service provider pages depicting graphical representations of selected seats from overhead map and virtual views for ticketed event of interests. In this example, an overhead 2D map to the left of screenshot 600 can be linked directly to the interactive 3D view to the right. As shown, an arrow from two seats on the overhead map shows the exact seats from which the 3D view on the right is shown.

FIGS. 6B and 6C illustrate representations of mobile devices depicting various screenshots of exemplary service provider pages that utilize map and virtual views according to various embodiments of the present invention. Mobile device 610 represents a smart phone, while mobile device 620 represents a tablet computing device. Of course, other devices such as laptop computers can similarly be used for such purposes. In particular, devices 610, 620 and/or the like can be adapted to present the various enhanced two-dimensional seat maps discussed above

### Methods

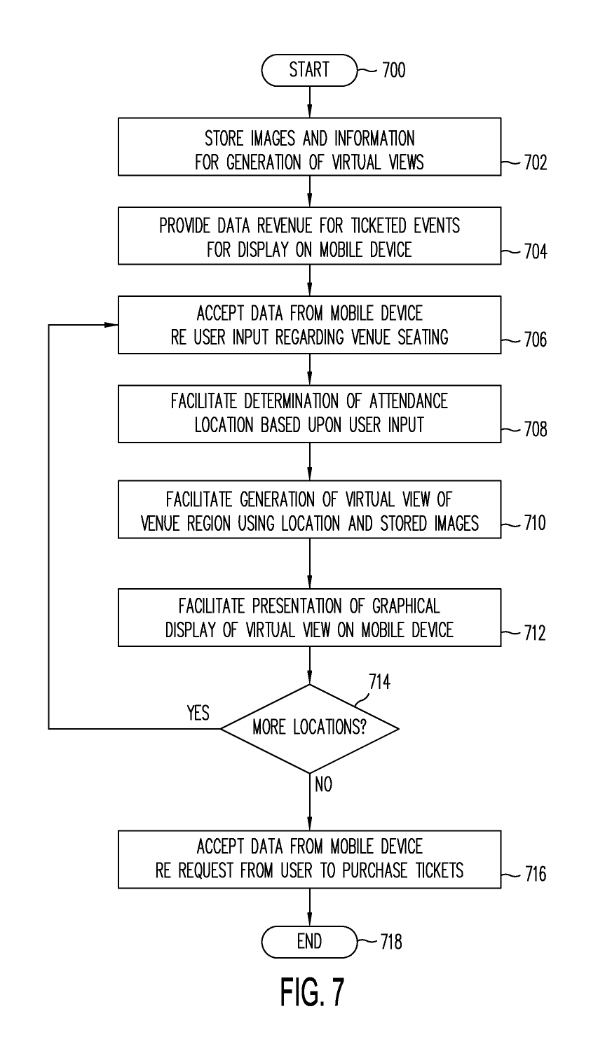

Although a wide variety of applications and methods involving the use of enhanced two-dimensional seat maps might be envisioned, one basic method is illustrated here. Turning lastly to FIG. 7, a flowchart of an exemplary method of facilitating a ticket selection for a ticketed event using a two-dimensional seat map is provided. In particular, such a method can involve using or operating any of the various computing components, devices, systems and/or networks described above. It will be readily appreciated that not every method step set forth in this flowchart is always necessary, and that further steps not set forth herein may also be included. For example, additional steps can include suggesting ticketed events, accepting payments, and delivering tickets, among others. Furthermore, the exact order of steps may be altered as desired for various applications. For example, step 702 can be performed in a number of different locations in the process, such as after step 710. Further, step 716 need not be performed in all cases, for example.

Beginning with a start step 700, images and/or information that can be used for the generation of virtual views can be stored at process step 702. Such images and information can include publicly available information, such as that which is readily available on the Internet, as well as private and/or proprietary information from any of a number of different sources, which may be obtained and used with the permission of the private owner(s). This stored information can be updated or augmented over time, as may be useful or suitable for a given service provider. Data or information regarding a given venue for ticketed events can then be provided to and/or used for generating a display on a user device, such as a phone or other mobile device, at process step 704. A user input regarding selecting or designating one or more seat locations or other venue regions of interest can be accepted at process step 706, after which the facilitation of a determination of an attendance location based upon the user input can be made at process step 708. It will be understood that not every attendance location need be a seat, such as in the case of standing room only, pavilion, general admission and other nonseated ticket categories. Furthermore, some embodiments may permit a user to see virtual two-dimensional views and/or virtual three-dimensional views from alternative locations, such as certain aisles, concourses, restrooms and concessions stands, for example.

At subsequent process step 710, facilitation of generating a virtual view with respect to the determined location can be performed. Such facilitation can be had on processor(s) on the user device itself. In some embodiments, facilitation can be performed by processor(s) on a remote server, with the actual generation of virtual views being performed either on the remote server as well or on the user device due to the activities of the remote server. Facilitating a presentation of the virtual view can then take place at process step 712. This can mean an overall view of the stage, playing field, court, rink, surface or the like, as well as zoomed views of different portions thereof. In addition, views from the determined location can also be made with respect to an orchestra pit, team benches, broadcasters, and other auxiliary locations of interest within the venue. Again, such facilitation can take place locally on the user device, and/or remotely at a separate server. In some embodiments, various facilitation steps can be performed by the transmission of modules, programs, applications, data, images and the like from the remote server, upon which multiple steps can be performed locally at the user device due to such prior facilitation.

An inquiry can then be made at a decision step 714 as to whether more locations for views should be determined. This could involve, for example, a user deciding to see what the view at the venue looks like from different seats, rows or sections. Where such additional locations are to be input, the method can revert back to step 706, and the steps are then repeated through step 714. Once all locations have been determined though, then the method continues to process step 716.

At step 716, acceptance of data from the user device regarding a request from the user to purchase tickets can then take place, after which the method finishes at end step 718. Further steps not depicted can include, for example, accepting switching between different venues, inquiring as to amenities such as concessions or restrooms with respect to a given attendance location. Other process steps can include, for example, accepting user input regarding future notices or desire to purchase tickets at the given venue or for a given performer at a different venue, as later information regarding such events may become available. Other steps can involve providing movie like views as the virtual location changes from one seat to another, as may be desired.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Various changes and modifications may be practiced, and it is understood that the invention is not to be limited by the foregoing details, but rather is to be defined by the scope of the claims.

What is claimed is:

1. A computing system, comprising:
one or more communication interfaces adapted to couple the computing system to a remotely located computing device;
one or more storage components adapted to store event information regarding one or more ticketed events, venue information regarding seating arrangements, seat views or information adapted for use in facilitating the generation of virtual views, or any combination thereof; and
one or more processors in communication with the one or more communication interfaces and the one or more storage components, said one or more processors being adapted to provide data to be displayed on the remotely located computing device to a user thereof, the data including information regarding a venue that is used for one or more ticketed events, to facilitate the acceptance of data from the computing device, the data including information regarding a first input from the user concerning seating arrangements for the venue, to facilitate a determination of a first attendance location for a ticketed event at the venue based upon the first input, and to facilitate the generation of a first virtual view of a region of interest at the venue from the determined first attendance location, wherein the generation of a first virtual view involves the use of scalable vector graphics and HTML5.

2. The computing system of claim 1, wherein said one or more processors are further adapted to facilitate the presentation of a graphical display to the user on the mobile computing device involving the first virtual view.

3. The computing system of claim 1, wherein said one or more processors are further adapted to accept a request to purchase tickets to the ticketed event from the user, wherein the request is based at least in part on the display of the first virtual view.

4. The computing system of claim 1, wherein the attendance location is a specific seat at the venue selected by the user.

5. The computing system of claim 1, wherein said one or more processors are further adapted to facilitate the acceptance of a second input from the user regarding alternative seating arrangements for the venue, facilitate the determination of a second attendance location for the ticketed event at the venue based upon the second input, facilitate the generation a second virtual view from the determined second attendance location, and facilitate providing a display to the user the second virtual view.

6. The computing system of claim 1, wherein the remotely located computing device is a mobile device.

7. The computing system of claim 6, wherein the mobile device is a cellular telephone.

8. The computing system of claim 1, wherein the first virtual view is also generated from images, information or both that are stored on the one or more storage components.

9. A non-transitory medium having a plurality of machine-readable instructions which, when executed by one or more processors of a server controlled by a service provider, are adapted to cause the server to perform a method comprising:
providing data to be displayed on a mobile computing device to a user thereof, the data including information regarding a venue that is used for one or more ticketed events, said providing being performed electronically by a processor;
facilitating the acceptance of data from the mobile computing device, the data including information regarding a first input from the user concerning seating arrangements for the venue;
facilitating a determination of a first attendance location for a ticketed event at the venue based upon the first input;
facilitating the generation of a first virtual view of a region of interest at the venue from the determined first attendance location, wherein the generation of a first virtual view involves the use of scalable vector graphics and HTML5; and
facilitating the presentation of a graphical display to the user on the mobile computing device involving the first virtual view.

10. The non-transitory medium of claim 9, wherein the method further includes the step of:
accepting from the mobile computing device a request to purchase tickets to the ticketed event from the user, wherein said request is based at least in part on the display of the first virtual view.

11. The non-transitory medium of claim 9, wherein the attendance location is a specific seat at the venue selected by the user.

12. The non-transitory medium of claim 9, wherein the method further includes the step of:
storing information, images or both, wherein the stored information, images or both are used in facilitating the generation of the first virtual view.

13. The non-transitory medium of claim 9, wherein the method further includes the step of:
accepting further data from the mobile computing device, the further data including information regarding a second input from the user regarding alternative seating arrangements for the venue;
facilitating a determination of a second attendance location for the ticketed event at the venue based upon the second input;
facilitating the generation of a second virtual view of the venue from the determined second attendance location; and
facilitating the presentation of a graphical display to the user on the mobile computing device involving the second virtual view.

14. A method of facilitating a ticket selection for a ticketed event, the method comprising:
providing data to be displayed on a mobile computing device to a user thereof, the data including information regarding a venue that is used for one or more ticketed events, said providing being performed electronically by a processor;
accepting data from the mobile computing device, the data including information regarding a first input from the user concerning seating arrangements for the venue;
facilitating a determination of a first attendance location for a ticketed event at the venue based upon the first input;
facilitating the generation of a first virtual view of a region of interest at the venue from the determined first attendance location, wherein the generation of a first virtual view involves the use of scalable vector graphics and HTML5; and
facilitating the presentation of a graphical display to the user on the mobile computing device involving the first virtual view.

15. The method of claim 14, wherein the mobile computing device is a cellular telephone.

16. The method of claim 14, further including the step of:
storing information, images or both, wherein the stored information, images or both are used in facilitating the generation of the first virtual view.

17. The method of claim 14, further including the step of:
accepting further data from the mobile computing device, the further data including information regarding a request to purchase tickets to the ticketed event from the user, wherein said request is based at least in part on the graphical display of the first virtual view.

18. The method of claim 14, wherein the attendance location is a specific seat at the venue selected by the user.

19. The method of claim 14, further including the steps of:
accepting further data from the mobile computing device, the further data including information regarding a second input from the user regarding alternative seating arrangements for the venue;
facilitating a determination of a second attendance location for the ticketed event at the venue based upon the second input;
facilitating the generation of a second virtual view of the venue from the determined second attendance location; and
facilitating the presentation of a graphical display to the user on the mobile computing device involving the second virtual view.

20. The method of claim 19, wherein the first and second virtual views are at different areas within the venue.
